(19) United States
(12) Patent Application Publication
(10) Pub. No.: US 2025/0318976 A1
(43) Pub. Date: Oct. 16, 2025

(54) Magnetic Tactile Stimulation Device for Managing Trichotillomania

(71) Applicant: SOTIRIA KAMILARI, ATHENS (GR)

(72) Inventor: SOTIRIA KAMILARI, ATHENS (GR)

(21) Appl. No.: 18/633,549

(22) Filed: Apr. 12, 2024

(51) Int. Cl. A61H 1/00

(52) U.S. Cl. CPC A61H 1/00; A61H 2201/0107; A61H 2201/0153; A61H 2201/0157; A61H 2201/1253; A61H 2201/1611; A61H 2201/165

(57) ABSTRACT

The invention disclosed herein is a tactile simulation device designed to provide a simulated tactile sensation through the use of a magnetic coupling mechanism. The device features a neck-engaging loop configured to be worn around a user's neck and a detachable element that can be releasably engaged with the neck-engaging loop through magnetic attraction. The neck-engaging loop houses a first magnet within an internal cavity of a magnet housing, and the detachable element contains a second magnet within an internal cavity of a second magnet housing at one end. The arrangement of the first and second magnets facilitates a releasable coupling through magnetic attraction, allowing the detachable element to simulate a tactile sensation upon its detachment and reattachment.

### FIELD OF INVENTION

The present invention relates generally to the field of therapeutic devices, specifically to a wearable device designed to aid individuals suffering from Trichotillomania by providing a tactile stimulation alternative to hair pulling. The device utilizes magnetic components to simulate the sensation of hair pulling.

### BACKGROUND

In the realm of mental health and behavioral disorders, Trichotillomania (TTM) stands as a particularly challenging condition characterized by an irresistible urge to pull out one's hair, leading to noticeable hair loss and significant distress. This disorder, also known as Trich, affects individuals across various demographics and has been the subject of increased attention within the medical and psychological communities. Despite this, solutions to mitigate the symptoms of TTM have been limited, predominantly focusing on behavioral therapy and medication, which may not be effective for all individuals. Furthermore, these interventions do not provide immediate relief or a tangible mechanism for redirecting the compulsive behavior associated with TTM.

The limitations of existing interventions underscore the need for innovative approaches that offer immediate, tangible relief and can serve as a complementary tool in managing the disorder. The use of objects to distract or redirect compulsive behaviors has shown promise in various contexts, such as the use of fidget spinners for stress relief. However, these solutions are not specifically tailored to address the unique needs of individuals with TTM, nor do they replicate the specific sensation associated with hair pulling, which is a critical aspect of the disorder's compulsive nature.

The development of a tool that can mimic the sensation of hair pulling while providing a harmless outlet for the compulsion has the potential to fill a significant gap in TTM management strategies. Such a tool would need to be portable, discreet, and capable of mimicking the tactile sensation associated with pulling hair to effectively redirect the urge. Additionally, the design must consider the aesthetic appeal and the personalization of the experience to encourage regular use and integration into daily life. The introduction of a device that addresses these considerations could represent a pivotal advancement in the support and management of individuals living with Trichotillomania, offering a new avenue for relief and control over their symptoms.

It is within this context that the present invention is provided.

### SUMMARY

The present invention relates to a tactile simulation device designed to simulate a tactile sensation through the use of a neck-engaging loop and a detachable element that releasably engages with each other via magnetic attraction. The device comprises a first magnet housed within the neck-engaging loop and a second magnet within the detachable element, arranged to couple through magnetic attraction to simulate a tactile sensation upon detachment.

In some embodiments, the tactile simulation device further comprises one or more decorative objects affixed along the length of the detachable element, opposite the second magnet housing. This feature enhances the aesthetic appeal of the device, making it not only functional but also fashionable.

In certain embodiments, the decorative objects may include a variety of materials such as pearls, crystals, beads, raw crystals, aquamarine, amethyst, hematite, clear quartz, jade, polished crystals, rose quartz, silver hematite, gold hematite, silver, and gold. This variety allows for personalization and customization, catering to the preferences of different users.

In some embodiments, the device is provided with multiple detachable elements featuring different chains of decorative objects. This allows wearers to choose between various styles and designs, further enhancing the customizability of the device.

In certain embodiments, the first and second magnets are permanent magnets with opposing polarizations. This facilitates the detachable magnetic coupling, ensuring a reliable and consistent magnetic attraction that can be easily separated and reattached by the user.

In some embodiments, the detachable element comprises a strand-like configuration. This design choice further simulates the tactile sensation, closely mimicking the experience the device aims to replicate.

In certain embodiments, the neck-engaging loop is available in various sizes to accommodate different neck sizes. This ensures a comfortable fit for a wide range of users.

In some embodiments, the magnets are secured within their respective magnet housings by an adhesive. This method of securing the magnets ensures their stability and durability within the device.

In certain embodiments, the magnets are contained within sealed chambers formed within their respective magnet housings. This provides additional protection for the magnets, safeguarding against damage and wear.

In some embodiments, the magnet housings are coupled to the neck-engaging loop and the detachable element via loops or other fastening means. This connection method provides a secure attachment while allowing for the detachable functionality of the element.

In certain embodiments, the neck-engaging loop is offered in materials such as gold, silver, black, and rose gold finishes. This selection of finishes allows users to choose a device that matches their personal style and preferences.

In some embodiments, the detachable element is configured with a textured surface. This texture enhances the tactile sensation during the detachment and reattachment process, providing additional sensory feedback to the user.

In certain embodiments, the neck-engaging loop includes an integrated clasp mechanism. This mechanism allows for easy removal and securement around the user's neck, combining functionality with ease of use.

In some embodiments, one or more of the magnet housings comprise a set of protrusions positioned about the edges of the internal cavity, the protrusions being configured to fold inwards to secure the magnets within the cavity. This helps maintain a simple construction for the housings whilst providing improved retainment of the magnets held within.

### BRIEF DESCRIPTION OF THE DRAWINGS

Various embodiments of the invention are disclosed in the following detailed description and accompanying drawings.

FIG. 1 illustrates an example isometric view of the tactile simulation device, showing the neck-engaging loop, the magnet housings in their coupled state, and the detachable element adorned with decorative objects.

FIG. 2 illustrates an example close-up view of the detachable coupling mechanism, showing the first and second magnet housings in a detached state to reveal the positioning of the magnets within.

FIG. 3 illustrates an example components view of the detachable coupling mechanism with the magnets removed from their housings to expose the hollow cavities designed to secure the magnets.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “connected,” “attached,” or “coupled” to another feature or element, there may or may not be intervening features or elements present. The features and elements described with respect to one embodiment can be applied to other embodiments.

The terms “first,” “second,” and the like are used to distinguish different elements or features, but these elements or features should not be limited by these terms. A first element or feature described can be referred to as a second element or feature and vice versa without departing from the teachings of the present disclosure.

The term “neck-engaging loop,” as used herein, refers to any structure or assembly designed to fit around or lay upon the neck of a user. This term is intended to encompass a variety of forms, including, but not limited to, flexible bands, rigid collars, or segmented chains. The neck-engaging loop may be constructed from various materials, including metals, plastics, fabrics, or composites, and may include a fastening mechanism such as a clasp, hook-and-loop fastener, magnetic closure, or slip-on arrangement allowing for size adjustment or securement.

Regarding the terms “magnet” and “magnetic attraction” as used in the context of this invention, these refer to the use of one or more magnetic elements capable of exerting a force on another magnetic element across a distance, facilitating the detachable coupling between the neck-engaging loop and the detachable element. The magnets described herein may be of any type suitable for the described purpose, including permanent magnets such as neodymium, ferrite, or samarium-cobalt magnets, and may be chosen based on their magnetic strength, size, cost, or other relevant factors. The configuration of these magnets within their housings is designed to ensure that the magnetic force is sufficient to secure the detachable element in place during normal use, yet allows for intentional detachment by the user with a deliberate force.

### Description of Drawings

The present invention relates generally to a tactile simulation device, and more particularly, to a device designed to simulate a tactile sensation through the use of a detachable element and a neck-engaging loop, which are magnetically coupled. The invention aims to provide a novel approach to simulating tactile sensations in a wearable format, offering a unique method for individuals to experience a simulated tactile feedback through the act of attaching and detaching components of the device.

The invention comprises a neck-engaging loop, which is intended to be worn around the user's neck, and a detachable element that is designed to releasably engage with the neck-engaging loop via a magnetic coupling mechanism. The neck-engaging loop houses a first magnet within a magnet housing, and the detachable element is equipped with a second magnet, enabling the two parts to be magnetically coupled. This magnetic coupling not only facilitates the easy attachment and detachment of the detachable element but also simulates a tactile sensation that the user experiences through the act of detachment.

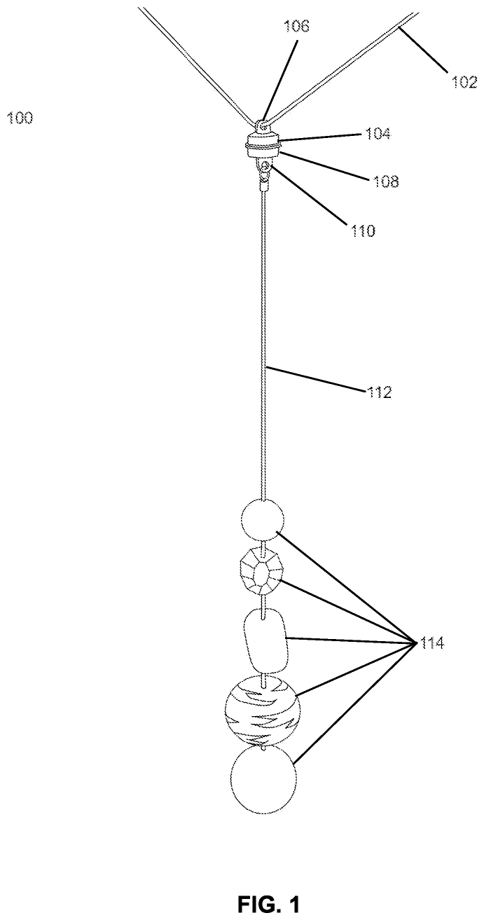

Referring to FIG. 1, an example implementation of a first embodiment of the invention is illustrated, a wearable tactile simulation device 100 designed for simulating a tactile sensation through magnetic coupling.

The device 100 includes a neck-engaging loop 102, designed to be worn around the user's neck. The first magnet housing 104 is coupled to the neck-engaging loop 102 via a loop 106, demonstrating a means for securing the magnet housing to the loop, ensuring that it remains in place during use. The first magnet housing 104 contains a first magnet (not shown) within its internal cavity, positioned to magnetically interact with a second magnet (also not shown) housed within the second magnet housing 108.

The second magnet housing 108 is illustrated as being magnetically coupled to the first magnet housing 104. This magnetic coupling facilitates the detachable nature of the device, allowing users to simulate a tactile sensation through the act of attaching and detaching the second magnet housing 108 from the first magnet housing 104. The second magnet housing 108 is coupled to the detachable element 112 via another loop 110.

The detachable element 112 is depicted as a dangling string/chain, designed to mimic the appearance and tactile sensation of a strand of hair. This element serves as the primary medium through which the tactile simulation is experienced by the user. Attached to the bottom of the detachable element 112 is a series of decorative objects 114, including pearls, quartz, and gems, providing an aesthetic appeal to the device. These decorative objects not only serve to enhance the visual attractiveness of the device but also provide a means for the user to grip and interact with the detachable element 112, facilitating the simulation of the tactile sensation.

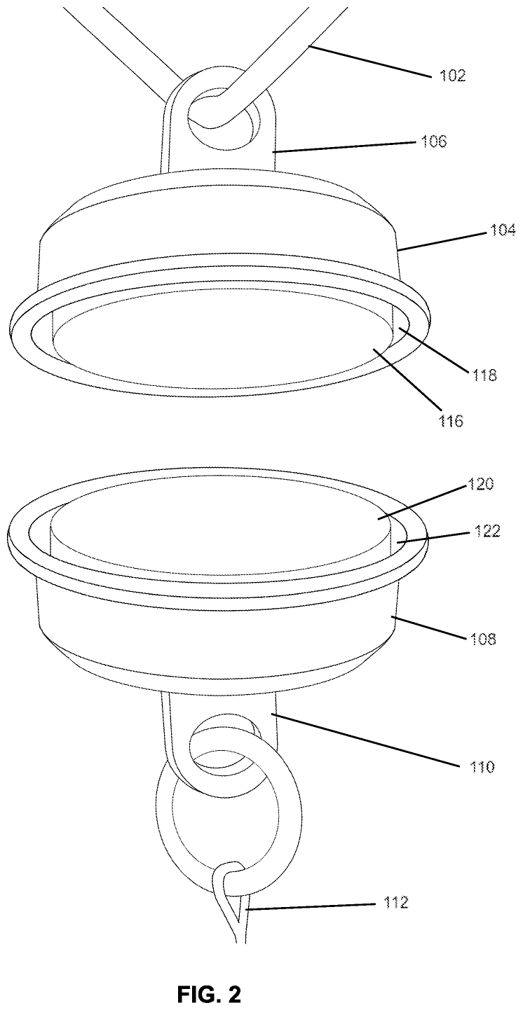

Referring to FIG. 2, an isometric close-up view of the example detachable coupling mechanism of the invention is presented, highlighting the interaction between the first magnet housing 104 and the second magnet housing 108. The first magnet housing 104 is shown in a detached state from the second magnet housing 108, allowing for a clear view of the first magnet 116 positioned within the upper hollow cavity 118 of the first magnet housing 104. Similarly, the second magnet 120 is secured within the lower hollow cavity 122 of the second magnet housing 108. The configuration illustrates how the magnets 116 and 120 are arranged to facilitate magnetic attraction and coupling between the neck-engaging loop and the detachable element. The magnets may be affixed within their respective housings 104 and 108 using adhesive or another securing method, ensuring they remain in place during the coupling and decoupling processes.

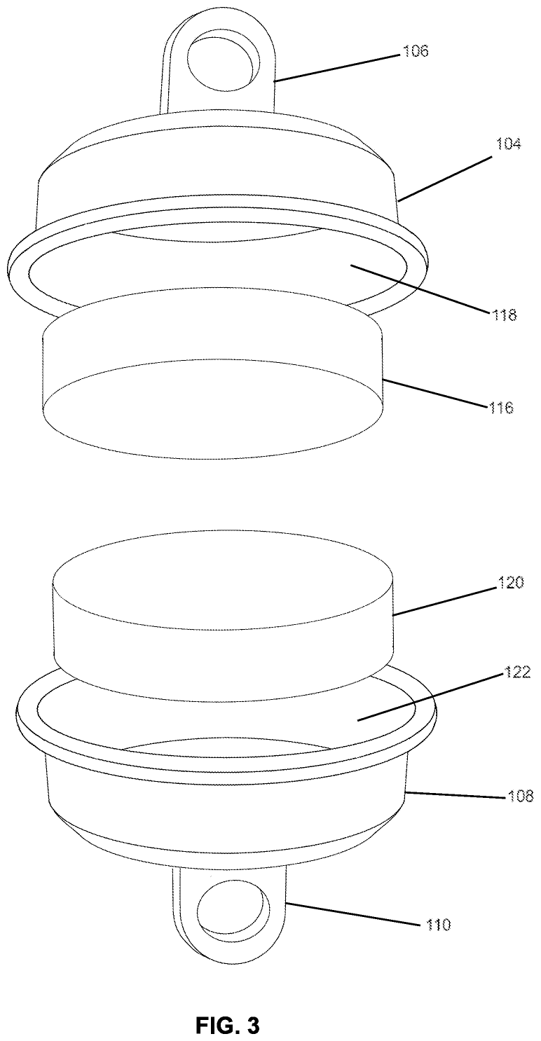

FIG. 3 provides a components view of the detachable coupling mechanism, with the cylindrical magnets 116 and 120 removed from their respective magnet housings 104 and 108. This view exposes the interior surfaces of the hollow cavities 118 and 122.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the tactile simulation device of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tactile simulation device, comprising:
a neck-engaging loop configured to be worn around a user's neck,
a first magnet housing coupled to the neck-engaging loop, the first magnet housing forming an internal cavity;
a first magnet secured within the internal cavity of the magnet housing of the neck-engaging loop; and
a detachable element configured to releasably engage with the first magnet via a second magnet secured within an internal cavity of a second magnet housing disposed at one end of the detachable element;
wherein the magnet of the neck-engaging loop and the second magnet of the detachable element are arranged to releasably couple through magnetic attraction to simulate a tactile sensation upon detachment.

2. The tactile simulation device of claim 1, further comprising one or more decorative objects affixed along the length of the detachable element, opposite the second magnet housing.

3. The tactile simulation device of claim 2, wherein the decorative objects include one or more of the following: pearls, crystals, beads, raw crystals, aquamarine, amethyst, hematite, clear quartz, jade, polished crystals, rose quartz, silver hematite, gold hematite, silver, and gold.

4. The tactile simulation device of claim 2, wherein the device comprises multiple detachable elements with different chains of decorative objects, which a wearer can choose between.

5. The tactile simulation device of claim 1, wherein the first magnet and the second magnet are permanent magnets with opposing polarizations, facilitating the detachable magnetic coupling.

6. The tactile simulation device of claim 1, wherein the detachable element comprises a strand-like configuration to further simulate the tactile sensation.

7. The tactile simulation device of claim 1, wherein the neck-engaging loop is provided in various neck sizes.

8. The tactile simulation device of claim 1, wherein the magnets are secured within their respective magnet housings by an adhesive.

9. The tactile simulation device of claim 1, wherein the magnets are secured within sealed chambers formed within their respective magnet housings.

10. The tactile simulation device of claim 1, wherein the magnet housings are coupled to the neck-engaging loop and the detachable element via loops or other fastening means.

11. The tactile simulation device of claim 1, wherein the neck-engaging loop is provided in materials selected from the group consisting of gold, silver, black, and rose gold finishes.

12. The tactile simulation device of claim 1, wherein the detachable element is configured with a textured surface to enhance the tactile sensation during the detachment and reattachment process.

13. The tactile simulation device of claim 1, wherein the neck-engaging loop includes an integrated clasp mechanism allowing for easy removal and securement around the user's neck.

14. The tactile simulation device of claim 1, wherein one or more of the magnet housings comprise a set of protrusions positioned about the edges of the internal cavity, the protrusions being configured to fold inwards to secure the magnets within the cavity.
